(19) United States
(12) Patent Application Publication
(10) Pub. No.: US 2016/0338322 A1
(43) Pub. Date: Nov. 24, 2016

(54) Leash 33 Handsfree Multi dog leash

(71) Applicant: Kimberly Letke, Joppa, MD (US)

(72) Inventor: Kimberly Letke, Joppa, MD (US)

(21) Appl. No.: 15/008,059

(22) Filed: Jan. 27, 2016

Related U.S. Application Data
(60) Provisional application No. 62/176,048, filed on Feb. 9, 2015.

(51) Int. Cl. A01K 27/00

(52) U.S. Cl. CPC A01K 27/003; A01K 27/005

(57) ABSTRACT

Leash 33 Hands Free Multiply dog leash a single pet leash system with a 8 inch loop at one end that has a snap hook inside the loop that can go around the waist and snaps onto the eye screw slider making it hands free and restrains a dog at one end and has an eye hook screws that slides up or down and then screws in place and attached to a snap hook for one, 2, 3, or more dogs and there is another eye hook screw that connects to the snap hook around the waist creating a hands free strapped around a user's waist, or can be used to attach another dog, so the system may be hands free during dog training walking,-running-, jogging and walking of Multiple dogs attached to the eye hook screws-eye slider combination and snap. The leash can be used as a normal leash that has a loop at one end for your hand or wrap the leash around your waist and attach the snap hook to the eye hook now it's a hands free Leash running in addition a running leash which is hands free one or more dogs depending attached to the next eye screw and eye sliders attached. The eye screw-eye sliders up the rope once in place the eye screw is tightens and the eye screw/slider are in a fixed position to restrain the dog along the rope, or around the waist thus another eye screw/slider to be adjusted for the walker or runner or to adjust for the other dog or dogs. Leash 33 comes normally with 1 or 2 or 3 eye screw and eye sliders combinations along the rope that is mildew resist and low voltage resist climbing rope.

The leash thickness may be chosen to match the size of the dog. small dog ¼, big dog ½ thick leash. The leash rope is climbing rope which is mildew resistance low voltage shock resistance ¼ is 150 lbs pull strength and ½ is 350 lbs pull strength as well as the rope floats in water.

### BACKGROUND

1. Field of Invention

The invention relates generally to a dog leash, which enables the pet owner to maintain control of one or more dogs while leaving hands and arms free to run, jog, walk, or simply attend to other life issues.

2. Related Art

Known leashes include a flexible fabric, rope, cable, chain intended to be hand held at one end and connected to a collar or harness on the dog at the other end. This traditional configuration allows only limited control of the animal and is dependent on arm strength and full focus and thus varies person to person.

Other leash systems have been developed that are waist or shoulder mounted by belts reducing the need for users to grasp the leash such as patent Mc Donough U.S. Pat. No. 5,038,719, Perrulli U.S. Pat. No. 5,842,444, Calhoun U.S. Pat. No. 6,192,835 (a belt with quick connects around a waist belt), Smith U.S. Pat. No. 4,667,624 (a child restraint), and Blake U.S. Pat. No. 5,718,1890.

Mc Donough U.S. Pat. No. 5,038,719 discloses a leash system in which one end of the leash hooks onto the dog collar D ring and the other end is permanently connected to a belt at a leash attachment point.

Calhoun U.S. Pat. No. 6,192,835—Embodiments of a hands-free leash system are described, which include quick-connect/disconnect fasteners to attach a belt around a person's waist, the belt to a leash, and the leash to a collar adapter. The leash system also includes a second attachment point on the belt for attaching a second end of the leash to the belt, so that the leash may be stored on the belt when not in use on the pet, instead of dangling from the belt or from the user's hand. Preferably, both of the leash attachment points on the belt are assemblies that may slide independently along the length of the belt, preferably all the way around the belt, so that the pet may maneuver around the user without tangling or twisting of the leash system. The quick-connect/disconnect feature of the fasteners allows for quick handling and response to any emergency

Perrulli U.S. Pat. No. 5,842,444 another waist leash system with a belt, with two fixed attachment rings sewn onto the belt.

### SUMMARY

The limitations inherent in the traditional hand held leashes creates the need for a device that transfers the stability and strength of the user's torso and frees the user's hands and arm, creating the opportunity to multi-task.

Shortening the leash aids in the training of a dog by controlling the dog's pace and distance from the user. The leash is constructed in a variety of lengths from four to ten feet. The size and type of dog and environment in which the leash will be used, dictates the appropriate length.

The unique cylindrical shape of the leash enables the user to more easily grasp the leash and maintain control of the dog. The leash is constructed in a variety of diameters from ¼ to a ½ inch. The size and type of dog dictates the appropriate diameter. The ¼ inch has a 133 pound work load; the ½ has a 350 pound work load. The leash is constructed of a blend of polyester and cotton and is mildew and low voltage shock resistant.

The loop of the leash can be hand held or secured around the user's waist. The eye slider and hook traverses the rope to adjust the loop depending on the user's waist size. The eye screw is firmly affixed to the selected location, fixing the size of the loop. At the opposite end of the leash, the snap hook (2) connects to the collar or harness of the dog. Additional eye screw (6) & eye slider (5) is for the second dog or 3 or 4th dog, depending on the dog and size and weight.

Attaching the eye screw (6) and snap hook allows for the addition of a second dog.

The distal end is securable to the coupling member (2) and is attached to the dog. The other distal end (4) is secured on the loop and attached to the eye screw (6). The eye slider (5) traverses the lead and is secured in place on the rope.

The first dog is restrained by the snap hook (2), the second dog is restrained by the eye screw 6 and eye slider 5 and the third dog is restrained by the eye screw (6) and eye slider (5).

Further features and advantages, as well as the structure and operation of various embodiments of the invention, are described in detail below with reference to the accompanying drawings.

### BRIEF DESCRIPTION OF THE DRAWINGS

Unless otherwise indicated, the accompanying drawings are not to scale. Several embodiments of the invention will be described with respect to the following drawings, in which like reference numerals represent like features throughout the figures, and in which:

FIG. 1 is a perspective view of a dog leash according to an embodiment of the invention;

FIG. 2 is a perspective view of the attachment portion, the (5) eye slider and (6) eye screw, of the dog leash depicted in FIG. 1;

FIG. 3 is a perspective view of the extension the dog leash depicted in FIG. 1, which allows the connection to multiple dogs;

FIG. 4 is a frontal view of the dog leash of FIG. 1 In use around a runner's waist;

FIG. 5 is a lateral view of the animal leash of FIG. 1 including an attachment assembly to allow control of multiple animals according to another embodiment of the invention;

### DETAILED DESCRIPTION

Some embodiments of the invention are discussed in detail below.

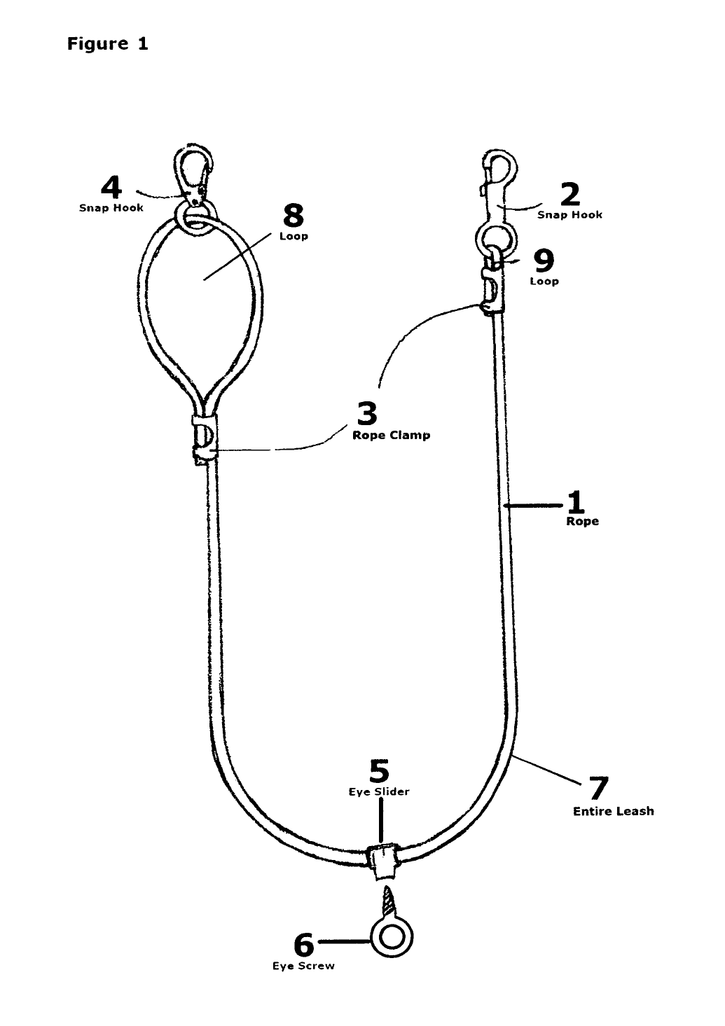

FIG. 1 includes the rope 1, for one or two dogs, and is constructed in a variety of lengths, while the standard leash is six feet. At one end, a snap hook 2 attaches to the dog leash 1. At the other end is a snap hook in a loop, which is worn around the user's waist. This snap hook 2 snaps onto the eye hook 6; they in conjunction traverse the rope to meet the snap hook 4 thus creating a hands free leash for one dog.

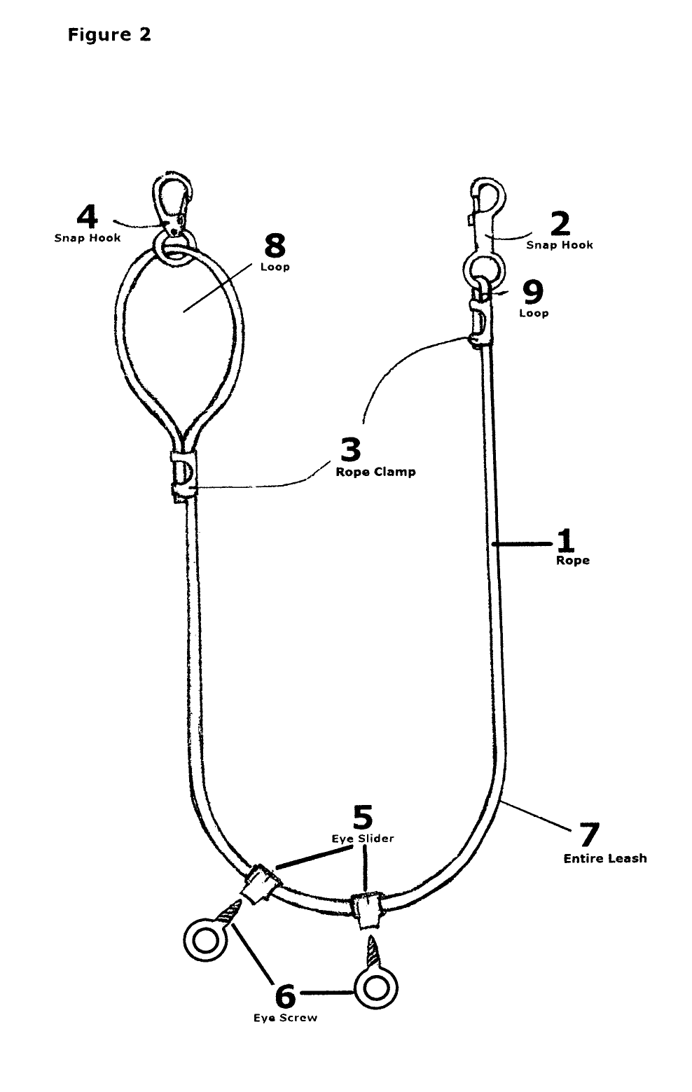

An additional dog can be connected to eye hook 6, with larger dogs requiring an additional eye slider 5 and eye hook 6. See FIG. 2.

Identifying the parts in FIG. 1 and FIG. 2: hands free multi dog leash. All the figures are relevant to FIGS. 1 & 2
#1 Rope (round-ploy and cotton mix, which is soft, mildew, and low voltage shock resistance.)
#2 Snap Hook
#3 Rope Clamp
#4 Snap hook in loop number 8
#5 Eye Slider
#6 Eye Screw
#7 Entire Leash
#8 loop for handle to hold rope as a regular leash

FIG. 2 is a perspective view of the which, starts at one end with a swivel snap hardware, continues to a loop and a rope clap 3, which holds the snap hook 2 in place. and then a slide eye ring 5 and a eye hook screw 6 and then another rope clamp #3 to hold the ropes in place and then a loop #8 used as a handle then another swivel snap variety of types either or number 2 or 1 can be attached or another type of snap.

place and then a loop #8 used as a handle then another swivel snap variety of types either or number 2 or 4 can be attached or another type of snap. The lead at one end is attached to a dog with part number 2 and then with wrapped around the waist number 4. Of a runner, jogger, walker. and number 5 slides up to a specified location and snapped on to the eye hook number 6 and screwed tight. (number 6 is loosen to allow number 5 to slide up and down the rope for adjustments) One the snap 6/5 and 4 are connected

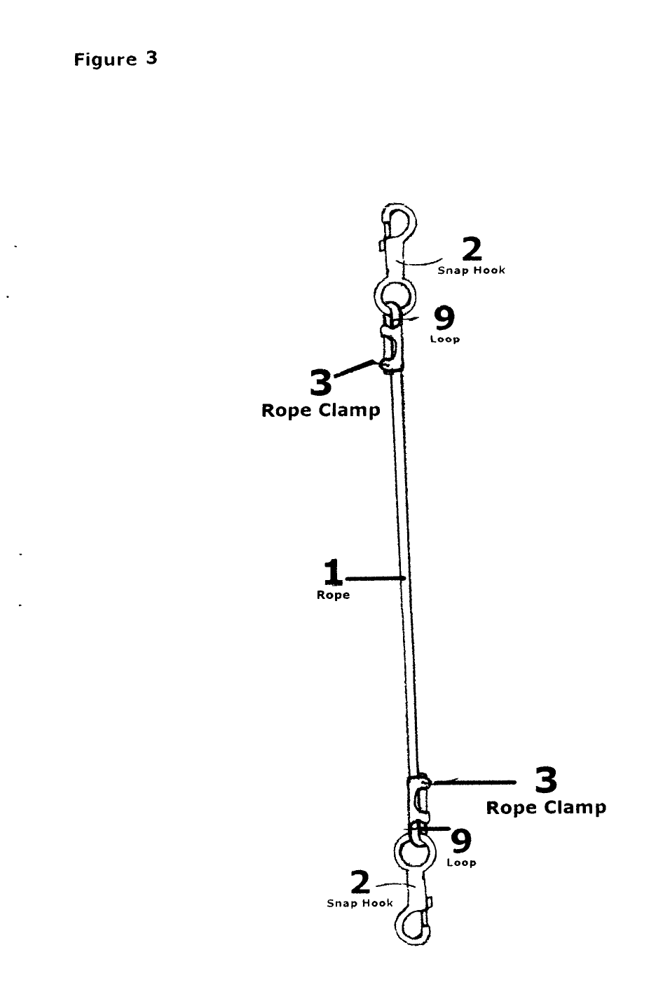

FIG. 3 is an extension, which ranges in length from two to six feet and is attached to the primary leash (1). At each end of the leash is a snap hook (4) and rope clamp (3). No 1 being the rope and at the end another No 3, loop #9 and No 2 swivel snap.

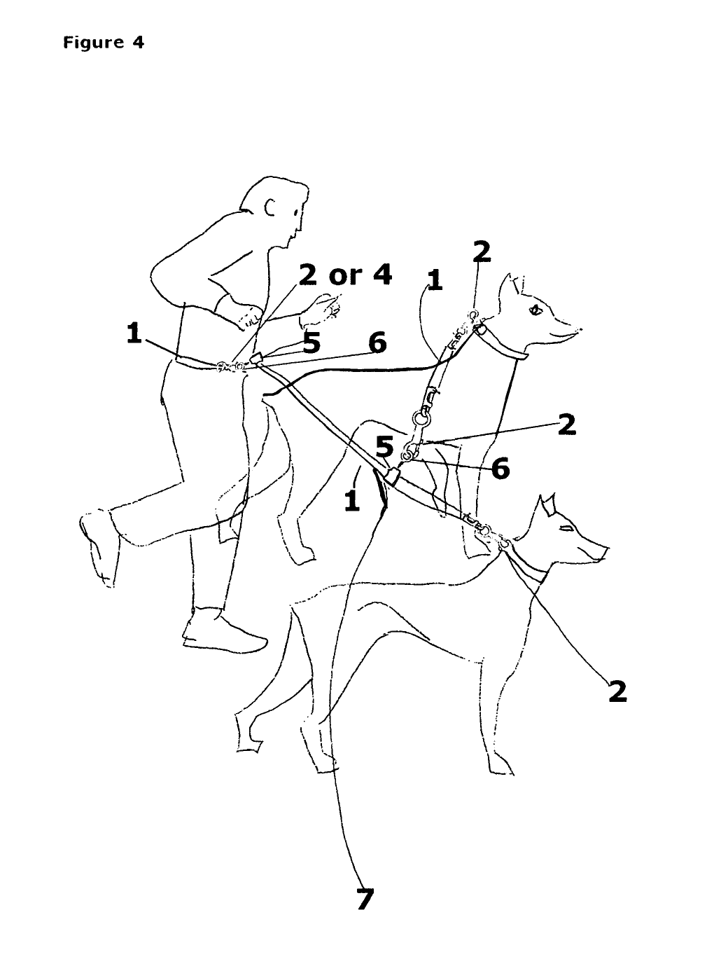

FIG. 4. is a frontal view of the dog leash of FIG. 1 including an attachment assembly to allow control of multiple animals according to another embodiment of the invention. An alternate use of the leash is for attachment to a toddler's harness as a simple, safe means for protecting a walking child in a public place.

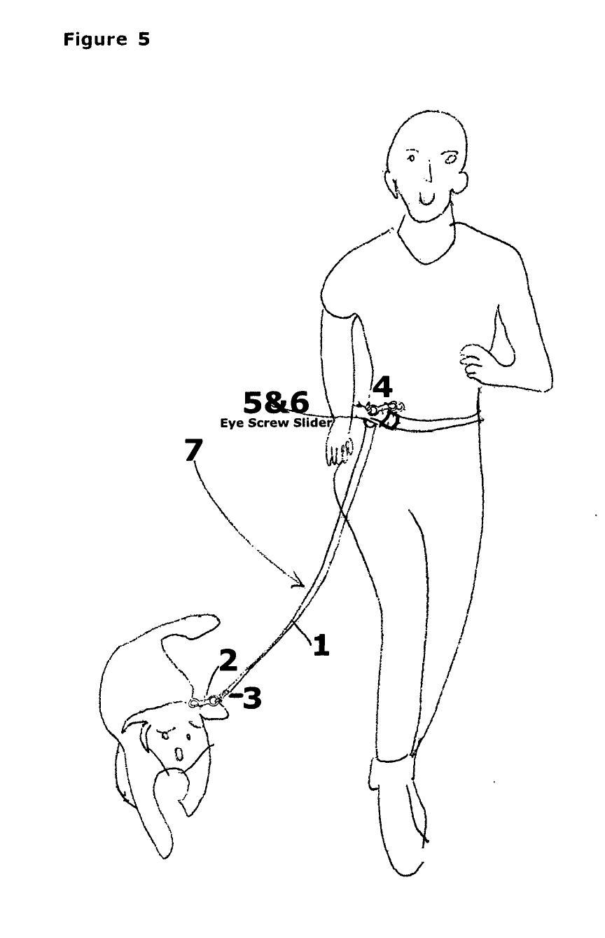

FIG. 5. is a lateral view of the animal leash of FIG. 1 including an attachment assembly to allow control of multiple animals according to another embodiment of the invention. The attachment is via the eye ring (5) and eye screw (6) to the primary leash (1)

1) The hands free, multiple dog leash comprising: a single length of resilient flexible material, wherein one end has a fixed rope clamp attached thereto, through which the material passes creating a loop, through which the snap hock attaches and wherein the second end has a fixed rope clamp attached thereto, through which the material passes creating a secondary loop, through which a flip snap clamp attaches and; multiple movable eye screw sliders capable of sliding without obstruction along the entirety of said length and; an attachable extension.

2) The hands free, multiple dog leash of claim 1, wherein said loop on said first end of leash attaches to said snap hook which attaches to a dog's collar, wherein said loop on second end can be used as a handle or hands free waist support.

3) The hands free, multiple dog leash of claim 1, wherein said eye ring is attached to said movable eye screw slider of said leash; said eye screw slider being attached to said flip snap forming a loop to encircle said waist, wherein said loop is formed from said flip snap connecting to said movable eye screw slider; said movable eye screw slider being attached to said length of leash to fix a maximum or minimum size of said loop.

4) The hands free, multiple dog leash of claim 1, wherein said snap hook on said first end of said leash is attached to a dog by connecting said snap hook to a separate collar worn by said dog.

5) The hands free, multiple dog leash of claim 1, wherein said eye ring is attached to said extension of said leash, wherein extension attaches by way of said snap hook to a dog's collar for leading two dogs at once.

6) The hands free, multiple dog leash of claim 1, wherein the length of leash is comprised of mildew-resistant polypropylene fibers wound to ¼, ½, ¾ or 1 inch thickness to accommodate multiple sized dogs; 1, 2 or 3 eye ring and eyes screws. Depending on dog size-weight and persons weight and size the person must use common sense.

7. Securing the Proximal end of the leash to the animal by way of the snap hook Number 2 and at the other end another snap hook 4 # within the Loop connects to an eye slider and eye screw (5 & 6). Number 5 and 6 sliders along the rope-leash to adjust around the waist or the second dog connection. An additional (5 & 6) eye slider and eye screw are added along the rope for a second dog or third dog to connect to the entire system No 7.

8. The Snap connects to the eye screw (6)-slider (5) (this adjust to the size of the persons waist and then tightened the eye screw number 6, once around the waist and connections are made. This creates a hands free leash and then you can walk one dog or 2 or 3- or 4 depending on the weight of the dog and training. The Second eye slider and screw adjust along the leash and are the eye screw tightens into the rope by screwing it tight. The leash length ranges from 6-8−10=12 feet depending on the dog-dogs or person. See FIGS. 1 and 2 more smaller dogs can be walked then larger dogs with just eye sliders and eye screws on a 6-8 foot leash.

9. A second leash or connecting rope FIG. 3 attach to the dog at one end and the eye screw and eye slider to the rope the leash creating a Multi dog leash and hands free leash.
